(19) United States
(12) Patent Application Publication
(10) Pub. No.: US 2014/0286324 A1
(43) Pub. Date: Sep. 25, 2014

(54) METHOD AND/OR SYSTEM FOR PASSIVE LOCATION ESTIMATION

(71) Applicant: QUALCOMM INCORPORATED, San Diego, CA (US)

(72) Inventors: Carlos Horacio Aldana, Mountain View, CA (US); Didier Johannes Richard van Nee, De Meern (NL)

(73) Assignee: QUALCOMM INCORPORATED, San Diego, CA (US)

(21) Appl. No.: 14/212,849

(22) Filed: Mar. 14, 2014

Related U.S. Application Data
(60) Provisional application No. 61/805,097, filed on Mar. 25, 2013.

(51) Int. Cl. G01S 5/02; H04W 84/12

(52) U.S. Cl. CPC G01S 5/0205; H04W 84/12
USPC 370/338

(57) ABSTRACT

Described are a system and method for a first wireless access point to compute timing parameters of neighboring access points based, at least in part, on beacon signals transmitted the neighboring access points. The first wireless access point may the broadcast the computed timing parameters to mobile devices. A mobile device having received the computed timing parameters may then compute an estimate of its location based, at least in part, on subsequently acquired beacon signals transmitted from the first access point and/or neighboring access points.

This application claims the benefit of priority to U.S. Provisional Patent Appl. No. 61/805,097, titled “Method and/or System for Passive Location Estimation,” filed on Mar. 25, 2013, and incorporated herein by reference in its entirety.

### BACKGROUND

1. Field

Subject matter disclosed herein relates to position estimation at a mobile device.

2. Information

The position of a mobile device, such as a cellular telephone, may be estimated based on information gathered from various systems. One such system may comprise a wireless local access network (WLAN) communication system comprising a number of access points to support communications for a number of mobile devices. A position estimate for a mobile device may be obtained, for example, through trilateration based on timing parameters such as round trip delay, code phase detections, signal strength estimates, and/or other measurements obtained through communication with one or more access points. A position estimate may be further based on known or reported locations of the access points.

### BRIEF DESCRIPTION OF THE FIGURES

Non-limiting and non-exhaustive examples will be described with reference to the following figures, wherein like reference numerals refer to like parts throughout the various figures.

FIG. 1 is a schematic block diagram depicting an example trilateration technique for determining an estimated position for a mobile device.

FIG. 2 is a flow diagram of a process performed at a wireless access point to provide timing parameters to one or more mobile devices according to an embodiment.

FIG. 3 is a flow diagram of a process performed at a mobile device for computing an estimated location of the mobile device according to an embodiment.

FIG. 4 is a schematic block diagram depicting an example wireless communication system including a plurality of computing platforms comprising one or more wireless access points and one or more mobile devices.

FIG. 5 is a schematic block diagram of a mobile device according to an embodiment.

### SUMMARY

Briefly, particular implementations are directed to a method comprising, at a mobile device: receiving a broadcast message from at least one access point including timing parameters of at least three access points, at least some of the timing parameters being determined at the at least one access point based, at least in part, on a measured time of arrival of beacon signals acquired at the at least one access point; acquiring beacon signals at the mobile device from the at least three access points; and computing an estimated location of the mobile device based, at least in part, on application of the timing parameters to times of arrival of the beacon signals acquired at the mobile device from the at least three access points.

Another particular implementation is directed to a mobile device comprising: receiver; and one or more processors to: obtain a broadcast message received at the receiver from at least one access point including timing parameters of at least two access points, at least some of the timing parameters being determined at the at least one access point based, at least in part, on a measured time of arrival of beacon signals acquired at the at least one access point; obtain a time arrival of at least one beacon signal acquired at the receiver from each of at least three access points; and compute an estimated location of the mobile device based, at least in part, on application of the timing parameters to times of arrival of the beacon signals acquired at the receiver from the at least three access points.

Another particular implementation is directed to an article comprising: a non-transitory storage medium including machine-readable instructions stored thereon which are executable by a special purpose computing apparatus of a mobile device to: obtain a broadcast message from at least one access point including timing parameters of at least two access points, at least some of the timing parameters being determined at the at least one access point based, at least in part, on a measured time of arrival of beacon signals acquired at the at least one access point; obtain a time of arrival of at least one beacon signal acquired from each of at least three access points; and compute an estimated location of the mobile device based, at least in part, on application of the timing parameters to times of arrival of the beacon signals acquired at the receiver from the at least three access points. In one particular implementation of the article, the estimated location of the mobile device is computed based, at least in part, on times of departure of the beacon signals acquired at the mobile device. In another particular implementation of the article, at least some of the timing parameters of the at least three access points are determined based, at least in part, times of departure of the beacon signals acquired at the at least one access point. In yet another particular implementation of the article the estimated location of the mobile device is computed based, at least in part, on a combination of a known map feature with the application of the timing parameters to the times of arrival to resolve at least one ambiguity. In another particular implementation of the article, the estimated location of the mobile device is computed based, at least in part, on a combination of a known map feature with the application of the timing parameters to the times of arrival to resolve at least one ambiguity.

Another particular implementation is directed to an apparatus at a mobile device, comprising: means for receiving a broadcast message from at least one access point including timing parameters of at least two access points, at least some of the timing parameters being determined at the at least one access point based, at least in part, on a measured time of arrival of beacon signals acquired at the at least one access point; means for acquiring beacon signals at the mobile device from the at least three access points; and means for computing an estimated location of the mobile device based, at least in part, on application of the timing parameters to times of arrival of the beacon signals acquired at the mobile device from the at least three access points. In a particular implementation, the means for computing the estimated location of the mobile device further comprises means for computing the estimated location based, at least in part, on a combination of a previously estimated location of the mobile device with the application of the timing parameters to the times of arrival to resolve at least one ambiguity. In another particular implementation, the means for computing the estimated location of the mobile device further comprises means for computing the estimated location based, at least in part, on times of departure of the beacon signals acquired at the mobile device. In another particular implementation, the timing parameters of the at least three access points are determined based, at least in part, times of departure of the beacon signals acquired at the at least one access point. In another particular implementation, the estimated location of the mobile device is computed based, at least in part, on a combination of a known map feature with the application of the timing parameters to the times of arrival to resolve at least one ambiguity. In another particular implementation, the estimated location of the mobile device is computed based, at least in part, on a combination of a known map feature with the application of the timing parameters to the times of arrival to resolve at least one ambiguity.

Another particular implementation is directed to an article comprising a non-transitory storage medium including machine-readable instructions stored thereon which are executable by a special purpose computing apparatus of a first access point to: obtain one or more beacon signals transmitted from one or more other access points compute timing parameters of the one or more other access points relative to a timing reference of the first access point; and initiate broadcasting of the computed timing parameters through the transceiver to mobile devices to enable the mobile devices to perform passive positioning operations based, at least in part, on application of the computed timing parameters to subsequently acquired beacon signals transmitted from the first access point and at least one of the one or more other access points. In one particular implementation of the article, the timing parameters of at least one of the one or more other access points are determined relative to a timing reference local to the first access point. In another particular implementation, the timing parameters of at least one of the one or more other access points are determined based, at least in part, on a distance between the first access point and the at least one of the one or more other access points. In another particular implementation, the timing parameters of at least one of the one or more other access points is determined based, at least in part, on transmission times of one or more beacon signals acquired at the first mobile device according to a timing reference local to the at least one of the one or more other access points. In another particular implementation, the computed timing parameters are broadcasted through the transceiver in one or more broadcast messages including a timing reference of the first access point, timing parameters determined for at least one of the one or more other access points, and a MAC address of the at least one of the one or more other access points.

Another particular implementation is directed to an article comprising: a non-transitory storage medium including machine-readable instructions stored thereon which are executable by a special purpose computing apparatus of a first access point to: obtain one or more beacon signals transmitted from one or more other access points; compute timing parameters of the one or more other access points relative to a timing reference of the first access point; and initiate broadcasting of the computed timing parameters through the transceiver to mobile devices to enable the mobile devices to perform passive positioning operations based, at least in part, on application of the computed timing parameters to subsequently acquired beacon signals transmitted from the first access point and at least one of the one or more other access points. In one particular implementation of the article, the timing parameters of at least one of the one or more other access points are determined relative to a timing reference local to the first access point. In another particular implementation of the article, the timing parameters of at least one of the one or more other access points are determined based, at least in part, on a distance between the first access point and the at least one of the one or more other access points. In another particular implementation of the article, the timing parameters of at least one of the one or more other access points is determined based, at least in part, on transmission times of one or more beacon signals acquired at the first mobile device according to a timing reference local to the at least one of the one or more other access points. In another particular implementation of the article, the computed timing parameters are broadcasted through the transceiver in one or more broadcast messages including a timing reference of the first access point, timing parameters determined for at least one of the one or more other access points, and a MAC address of the at least one of the one or more other access points.

Another particular implementation is directed to a first access point comprising: means for receiving one or more beacon signals transmitted from one or more other access points; means for computing timing parameters of the one or more other access points relative to a timing reference of the first access point; and means for broadcasting the computed timing parameters to mobile devices to enable the mobile devices to perform passive positioning operations based, at least in part, on application of the computed timing parameters to subsequently acquired beacon signals transmitted from the first access point and at least one of the one or more other access points.

It should be understood that the aforementioned implementations are merely example implementations, and that claimed subject matter is not necessarily limited to any particular aspect of these example implementations.

### DETAILED DESCRIPTION

As mentioned above, a position of a mobile device, such as a cellular telephone, may be estimated based on information gathered from various systems. One such system may comprise a wireless local access network (WLAN) communication system comprising a number of access points to support communications for a number of mobile devices. As also mentioned above, a position estimate for a mobile device may be obtained, for example, through trilateration based on timing parameters.

Trilateration at a mobile device may comprise measuring ranges to three or more transmitters positioned at fixed locations. For WLAN access points providing transmitters positioned at fixed locations, one such technique for measuring ranges for trilateration may comprise measuring a signal round trip time. This may involve, for example, a mobile device transmitting a fine timing measurement request frame to one or more access points and measuring a signal round trip time based on a time arrival of a messages transmitted in response to the fine timing measurement request frame. Such active ranging techniques may congest communication traffic in a WLAN system if in an operational environment with many users (e.g., at a sporting event in a stadium).

In an aspect, techniques described herein are directed to wireless access points in a WLAN that passively listen to beacon signals transmitted by other neighboring wireless access points to estimate or measure signal timing parameters. A wireless access point may then broadcast signal timing parameters that it had estimated or measured to mobile devices. With broadcasted signal timing parameters for three or more wireless access points and acquisitions of beacon signals from the three or more wireless access points, a mobile device may compute an estimate of its location.

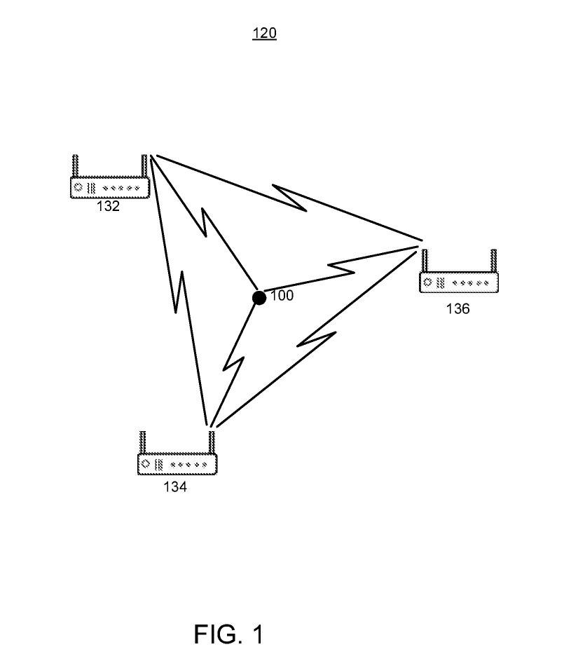

FIG. 1 is a schematic block diagram depicting an example trilateration technique for determining an initial estimated position for a mobile device 100. A wireless network 120 may provide voice or data communication for a number of wireless terminals including mobile device 100, for example, and may further support position estimation for the wireless terminals in addition to providing voice or data communication. Wireless network 120 may comprise any of a number of wireless network types, several examples of which are described below. Wireless network 120 for this example may comprise terrestrial-based wireless access transceivers 132, 134, and 136 that provide communication for a number of mobile devices such as, for example, mobile device 100. For simplicity, only a few transceivers 132, 134, and 136 are depicted and one mobile device 100 is depicted in FIG. 1. Of course, other examples may include a smaller or greater number of transmitters, and the configuration of transmitters depicted in FIG. 1 is merely an example configuration.

As shown in FIG. 1, in addition to wirelessly communicating with mobile device 100, wireless access transceivers 132, 134 and 136 may communicate with one another. In a particular implementation in which wireless access transceivers 132, 134 and 136 comprise IEEE std. 802.11 access points, wireless access transceivers 132, 134 and 136 may transmit and acquire beacon signals which include, for example, a MAC address of the transmitting device, a time of transmission (e.g., according to a local reference clock maintained by the transmitting device), just to provide a few examples. As discussed below, a wireless access transceiver may measure timing parameters in connection with local clock references at other wireless access transceivers (relative to its own local clock reference) and broadcast the measured timing parameters for use by mobile devices in positioning operations.

In a particular implementation discussed below, wireless access transceivers may comprise IEEE std. 802.11x access points (APs). Here, the following may be known by a mobile device and/or APs:
Intended center frequencies of transmit signals;
Time of departure of beacons signals transmitted by APs (from a time stamp embedded in acquired beacon signal according to local time reference of transmitting APs),
Locations of APs; and
Precise time of arrival of acquired beacon signals (according to local time reference of acquiring AP or mobile device).

Additionally, a TSF timer may have a 2̂64 0.1 nanosec wraparound time (equivalent to 58.5 years). In particular implementations, there may be no central clock reference that APs and mobile devices may maintain their own local reference clocks. A bandwidth of beacon signals transmitted by APs may be increased from 20 MHz to 160 MHz to accommodate more precise time stamps. Clock drift may also be measured and addressed.

According to an embodiment, an AP₁ in a wireless network may model its local timing reference and the local timing references of other APs in the wireless network according to expression (1) as follows:

AP₁(t)=t₁

APₘ(t)=αₘtₘ+βₘ (1)

where:
t₁ is a local timing reference for AP₁;
tₘ is a local timing reference for APₘ; and
αₘ and βₘ are timing parameters.

By listening to two beacon signals separately transmitted by AP₂ at departure times t_{1,2}^{tx}, t_{2,2}^{tx} (according to local time stamps that may be acquired at the a receiving AP) and received at AP₁ at arrival times t_{1,2}^{rx}, t_{2,2}^{rx}, AP₁ may solve for α₂ according to expression (2) as follows:

$${α}_{2} {t}_{1 , 2}^{tx} + {β}_{2} - {t}_{1 , 2}^{rx} = {α}_{2} {t}_{2 , 2}^{tx} + {β}_{2} - {t}_{2 , 2}^{rx} \\ {α}_{2} = \frac{{t}_{1 , 2}^{rx} - {t}_{2 , 2}^{rx}}{{t}_{1 , 2}^{tx} - {t}_{2 , 2}^{tx}} = \frac{{t}_{2 , 2}^{rx} - {t}_{1 , 2}^{rx}}{{t}_{2 , 2}^{tx} - {t}_{1 , 2}^{tx}} \qquad ( 2 )$$

Either of the two expressions above may be used to solve for β₂. Without loss of generality, β₂ may also be determined according to expression (3) as follows:

$${α}_{2} {t}_{2 , 2}^{tx} + {β}_{2} + {t}_{TOF , 12} = {t}_{2 , 2}^{rx} \\ {β}_{2} = {t}_{2 , 2}^{rx} - {t}_{TOF , 12} - \frac{{t}_{2 , 2}^{rx} - {t}_{1 , 2}^{rx}}{{t}_{2 , 2}^{tx} - {t}_{1 , 2}^{tx}} {t}_{2 , 2}^{tx} \qquad ( 3 )$$

Where:
t_{TOF,12} is the time of flight of a beacon signal from AP₁ to AP₂ (which is derivable from the known locations of AP₁ and AP₂).

For m≧2, values for αₘ and βₘ may be determined according to expression (4) as follows:

$${α}_{m} = \frac{{t}_{2 , m}^{rx} - {t}_{1 , m}^{rx}}{{t}_{2 , m}^{tx} - {t}_{1 , m}^{tx}} \\ {β}_{m} = {t}_{2 , m}^{rx} - {t}_{TOF , 1 m} - \frac{{t}_{2 , m}^{rx} - {t}_{1 , m}^{rx}}{{t}_{2 , m}^{tx} - {t}_{1 , m}^{tx}} {t}_{2 , m}^{tx} \qquad ( 4 )$$

As pointed out above, APs may broadcast timing parameters regarding timing references of other APs to mobile devices to enable the mobile devices to perform passive positioning operations (e.g., by acquisition of subsequently transmitted beacon signals and without transmitting any probe signals or fine timing measurement request frames, acknowledgement messages, etc.). For an APₘ, one or more broadcast message may comprise: MAC address for APₘ, αₘ (e.g., 16-bits in units of 0.00076 parts per million); and βₘ (e.g., 64-bits to be consistent with a 64-bit TSF counter).

With receipt of broadcast messages identified above and passively listening to beacon signals transmitted by APs, a mobile device (or “STA”) may compute an estimate of its location. Referring to the expressions above, the mobile device may model its time reference relative to a time reference of an AP₁ according to expression (5) as follows:

AP₁(t)=t₁

STA(t)=α₁t₁+β₁ (5)

The mobile device may then listen to beacon signals transmitted by AP₁ and AP₂ at departure times t₁^{tx}, t₂^{tx} and received at the mobile device at arrival times t₁^{rx}, t₂^{rx} to estimate α₁ according to expression (6) as follows:

$${α}_{1} {t}_{1}^{tx} + {β}_{1} - {t}_{1}^{rx} = {α}_{1} {t}_{2}^{tx} + {β}_{1} - {t}_{2}^{rx} \\ {α}_{1} = \frac{{t}_{1}^{rx} - {t}_{2}^{rx}}{{t}_{1}^{tx} - {t}_{2}^{tx}} \qquad ( 6 )$$

The parameter β₁ may still be unknown since time of flight of the beacon signals is not known. The mobile device may then listen to beacon signals transmitted by AP₁, AP₂ and AP₃ at departure times t₁^{tx}, t₂^{tx}, t₃^{tx} to compute the following mapping to the AP₁ clock domain:

T₁^{tx}=t₁^{tx}

T₂^{tx}=α₂t₂^{tx}+β₂

T₃^{tx}=α₃t₃^{tx}+β₃

With a mobile device located at a position (x,y) in a Cartesian coordinate system with a location of AP₁ at an origin (0,0), a location of AP₂, at (x₂,y₂) and a location of AP₃ at (x₃,y₃), the mobile device may estimate values of x and y subject to the following expressions (7):

c²(T₁^{rx}−α₁T₁^{tx}−β₁)²=x²+y²

c²(T₂^{rx}−α₁T₂^{tx}−β₁)²=(x−x₂)²+(y−y₂)²

c²(T₃^{rx}−α₁T₃^{tx}−β₁)²=(x−x₃)²+(y−y₃)² (7)

Where:
c is the speed of light.

In a particular implementation, values for x and y may be determined by solving for x and y in the system of equations of expression (7). Values for x and y may also be determined using particle filtering techniques. In one implementation, a particle filter (or other motion model or filtering technique such as a Kalman filter) implemented at a mobile device may apply known map features and timing parameters to times of arrival of beacon signals to resolve at least one ambiguity of a computed estimate of location of the mobile device. In another implementation, such a particle filter may combine one or more previously estimated locations of the mobile device with application of timing parameters to times of arrival of beacon signals to resolve at least one ambiguity of a computed estimate of location of the mobile device

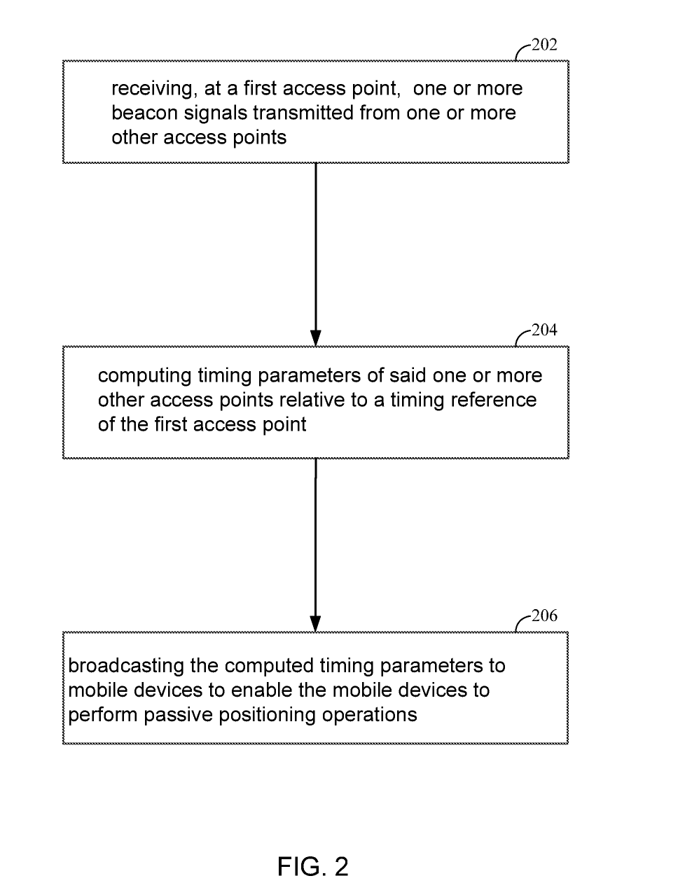

FIG. 2 is a flow diagram of a process performed at a wireless access point to provide timing parameters to one or more mobile devices according to an embodiment. At block 202, a first wireless access point may receive beacon signals transmitted by one or more other access points. At block 204, the first wireless access point may then compute timing parameters of the one or more other access points relative to a timing reference of the first access point, based at least in part, on the beacon signals received at block 202. For example, the first wireless access point may compute parameters α and β of at least one of the one or more other wireless access points relative to a timing reference of the first wireless access point according to expressions (2), (3) and (4) based, at least in part, on two beacon signals separately transmitted by the at least one of the one or more wireless access points and locations of the first wireless access point and the at least one of the one or more other wireless access points. At block 206, the first wireless access point may then broadcast timing parameters computed at block 204 to one or more mobile devices to enable the one or more mobile devices to perform passive positioning operations. As pointed out above, these passive positioning operations may be based, at least in part, on application of the broadcasted positioning parameters to subsequently acquired beacon signals transmitted from the first wireless access point and at least one of the one or more other wireless access points. As pointed out above, a broadcast message transmitted at block 206 may include, for example, a MAC addresses, and values for parameters α and β for the first wireless access point and the at least one of the one or more other wireless access points.

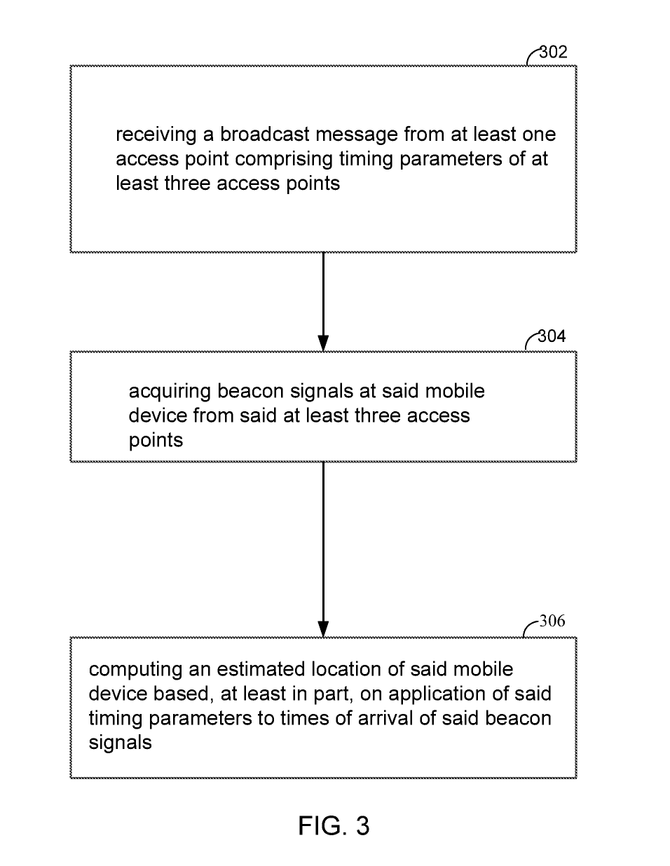

FIG. 3 is a flow diagram of a process performed at a mobile device for computing an estimated location of the mobile device according to an embodiment. At block 302, a mobile device may receive a broadcast message from at least one access point comprising timing parameters (e.g., α and β) of at least three access points. As pointed out above in a particular example, these timing parameters may include timing parameters computed at the wireless access point based, at least in part, on a measured time of arrival of beacon signals acquired at the wireless access point and according to expressions (2), (3) and (4). At block 304, the mobile device may acquire beacon signals transmitted by the at least three access points which are characterized by a time of transmission and a time of arrival. At block 306, the mobile device may then compute its location (x,y) based, at least in part, on application of timing parameters received at block 302 (e.g., α and β) to times of arrival of beacon signals from the at least three access points acquired at block 304 according to expression (7).

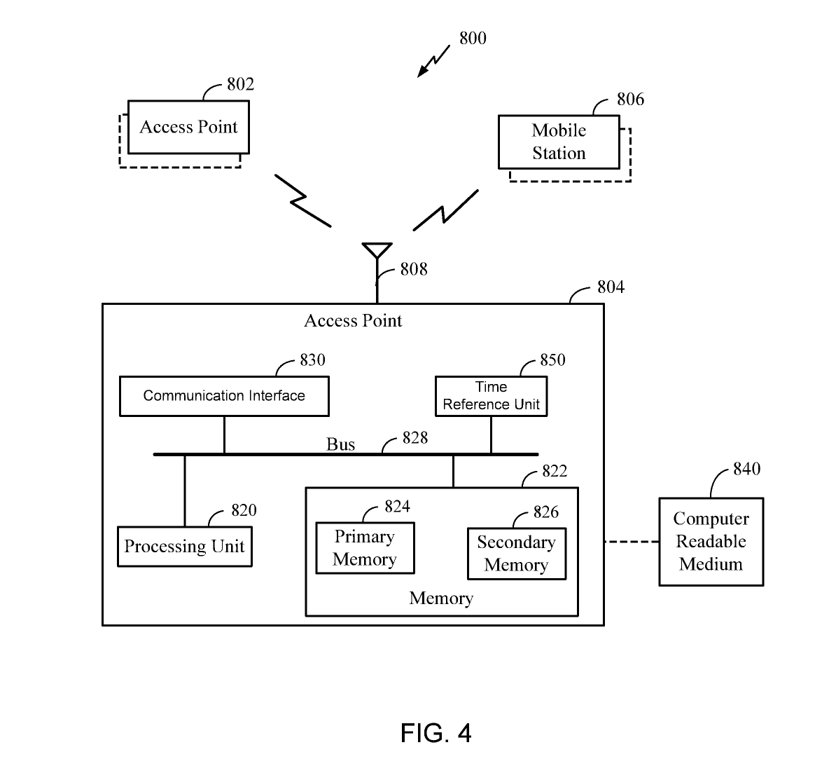

FIG. 4 is a schematic diagram illustrating an example system 800 that may include one or more devices configurable to implement techniques or processes described above, for example, in connection with FIG. 1. System 800 may include, for example, a first device 802, a second device 804, and a third device 806, which may be operatively coupled together through a wireless communications network. In an aspect, first device 802 may comprise an access point as shown, for example. Second device 804 may comprise and access point and third device 806 may comprise a mobile station or mobile device, in an aspect. Also, in an aspect, devices 802, 804 and 802 may be included in a wireless communications network may comprise one or more wireless access points, for example. However, claimed subject matter is not limited in scope in these respects.

First device 802, second device 804 and third device 806, as shown in FIG. 4, may be representative of any device, appliance or machine that may be configurable to exchange data over a wireless communications network. By way of example but not limitation, any of first device 802, second device 804, or third device 806 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof. Any of the first, second, and third devices 802, 804, and 806, respectively, may comprise one or more of an access point or a mobile device in accordance with the examples described herein.

Similarly, a wireless communications network, as shown in FIG. 4, is representative of one or more communication links, processes, or resources configurable to support the exchange of data between at least two of first device 802, second device 804, and third device 806. By way of example but not limitation, a wireless communications network may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 806, there may be additional like devices operatively coupled to wireless communications network 808.

It is recognized that all or part of the various devices and networks shown in FIG. 4, and the processes and methods as further described herein, may be implemented using or otherwise including hardware, firmware, software, or any combination thereof.

Thus, by way of example but not limitation, second device 804 may include at least one processing unit 820 that is operatively coupled to a memory 822 through a bus 828.

Processing unit 820 is representative of one or more circuits configurable to perform at least a portion of a data computing procedure or process. By way of example but not limitation, processing unit 820 may include one or more processors, controllers, microprocessors, microcontrollers, application specific integrated circuits, digital signal processors, programmable logic devices, field programmable gate arrays, and the like, or any combination thereof.

Memory 822 is representative of any data storage mechanism. Memory 822 may include, for example, a primary memory 824 or a secondary memory 826. Primary memory 824 may include, for example, a random access memory, read only memory, etc. While illustrated in this example as being separate from processing unit 820, it should be understood that all or part of primary memory 824 may be provided within or otherwise co-located/coupled with processing unit 820. In a particular implementation, memory 822 and processing unit 820 may be configured to perform the computation of timing parameters as set forth in block 204 of FIG. 2.

Secondary memory 826 may include, for example, the same or similar type of memory as primary memory or one or more data storage devices or systems, such as, for example, a disk drive, an optical disc drive, a tape drive, a solid state memory drive, etc. In certain implementations, secondary memory 826 may be operatively receptive of, or otherwise configurable to couple to, a computer-readable medium 840. Computer-readable medium 840 may include, for example, any non-transitory medium that can carry or make accessible data, code or instructions for one or more of the devices in system 800. Computer-readable medium 840 may also be referred to as a storage medium.

Second device 804 may include, for example, a communication interface 830 that provides for or otherwise supports the operative coupling of second device 804 to a wireless communications network at least through an antenna 808. By way of example but not limitation, communication interface 830 may include a network interface device or card, a modem, a router, a switch, a transceiver, and the like. In a particular implementation, antenna 808 in combination with communication interface 830 may be used to implement receiving beacon signals from access points or broadcasting computed timing parameters at blocks 202 and 206 of FIG. 2.

Second device 804 may include, for example, an input/output device 832. Input/output device 832 is representative of one or more devices or features that may be configurable to accept or otherwise introduce human or machine inputs, or one or more devices or features that may be configurable to deliver or otherwise provide for human or machine outputs. By way of example but not limitation, input/output device 832 may include an operatively configured display, speaker, keyboard, mouse, trackball, touch screen, data port, etc.

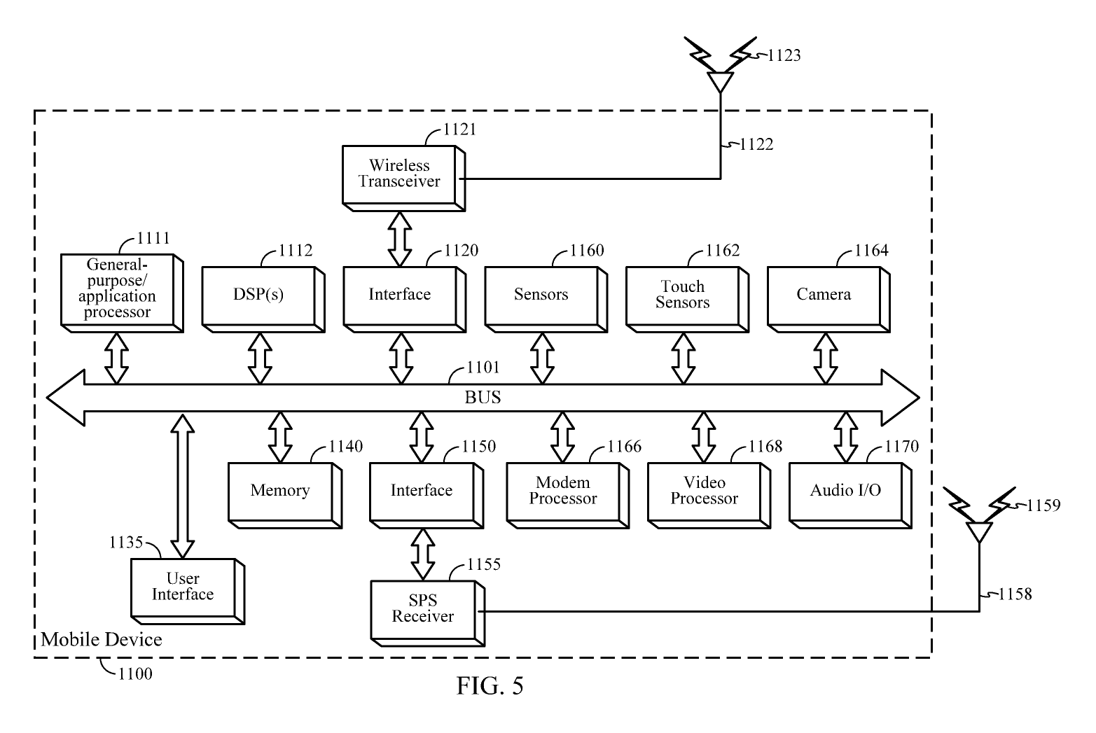

FIG. 5 is a schematic diagram of a mobile device according to an embodiment. Mobile device 100 (FIG. 1) or mobile device 806 (FIG. 4) may comprise one or more features of mobile device 1100 shown in FIG. 5. In certain embodiments, mobile device 1100 may also comprise a wireless transceiver 1121 which is capable of transmitting and receiving wireless signals 1123 via wireless antenna 1122 over a wireless communication network. Wireless transceiver 1121 may be connected to bus 1101 by a wireless transceiver bus interface 1120. Wireless transceiver bus interface 1120 may, in some embodiments be at least partially integrated with wireless transceiver 1121. Some embodiments may include multiple wireless transceivers 1121 and wireless antennas 1122 to enable transmitting and/or receiving signals according to a corresponding multiple wireless communication standards such as, for example, versions of IEEE Std. 802.11, CDMA, WCDMA, LTE, UMTS, GSM, AMPS, Zigbee and Bluetooth, just to name a few examples. In a particular implementation, wireless transceiver 1121 in combination with wireless antenna 1122 may be configured to perform actions set forth at blocks 302 (e.g., to receive a broadcast message) and 304 (e.g., to acquire beacon signals) of FIG. 3.

Mobile device 1100 may also comprise SPS receiver 1155 capable of receiving and acquiring SPS signals 1159 via SPS antenna 1158. SPS receiver 1155 may also process, in whole or in part, acquired SPS signals 1159 for estimating a location of mobile device 1000. In some embodiments, general-purpose processor(s) 1111, memory 1140, DSP(s) 1112 and/or specialized processors (not shown) may also be utilized to process acquired SPS signals, in whole or in part, and/or calculate an estimated location of mobile device 1100, in conjunction with SPS receiver 1155. Storage of SPS or other signals (e.g., signals acquired from wireless transceiver 1121) for use in performing positioning operations may be performed in memory 1140 or registers (not shown). As such, general-purpose processor(s) 1111, memory 1140, DSP(s) 1112 and/or specialized processors may provide a location engine for use in processing measurements to estimate a location of mobile device 1100. In a particular implementation, general-purpose processor(s) 1111, memory 1140, DSP(s) 1112 and/or specialized processors may be configured to compute an estimated location of a mobile device as set forth in block 306 of FIG. 3.

Also shown in FIG. 5, mobile device 1100 may comprise digital signal processor(s) (DSP(s)) 1112 connected to the bus 1101 by a bus interface 1110, general-purpose processor(s) 1111 connected to the bus 1101 by a bus interface 1110 and memory 1140. Bus interface 1110 may be integrated with the DSP(s) 1112, general-purpose processor(s) 1111 and memory 1140. In various embodiments, functions may be performed in response execution of one or more machine-readable instructions stored in memory 1140 such as on a computer-readable storage medium, such as RAM, ROM, FLASH, or disc drive, just to name a few example. The one or more instructions may be executable by general-purpose processor(s) 1111, specialized processors, or DSP(s) 1112. Memory 1140 may comprise a non-transitory processor-readable memory and/or a computer-readable memory that stores software code (programming code, instructions, etc.) that are executable by processor(s) 1111 and/or DSP(s) 1112 to perform functions described herein.

Also shown in FIG. 5, a user interface 1135 may comprise any one of several devices such as, for example, a speaker, microphone, display device, vibration device, keyboard, touch screen, just to name a few examples. In a particular implementation, user interface 1135 may enable a user to interact with one or more applications hosted on mobile device 1100. For example, devices of user interface 1135 may store analog or digital signals on memory 1140 to be further processed by DSP(s) 1112 or general purpose processor 1111 in response to action from a user. Similarly, applications hosted on mobile device 1100 may store analog or digital signals on memory 1140 to present an output signal to a user. In another implementation, mobile device 1100 may optionally include a dedicated audio input/output (I/O) device 1170 comprising, for example, a dedicated speaker, microphone, digital to analog circuitry, analog to digital circuitry, amplifiers and/or gain control. It should be understood, however, that this is merely an example of how an audio I/O may be implemented in a mobile device, and that claimed subject matter is not limited in this respect. In another implementation, mobile device 1100 may comprise touch sensors 1162 responsive to touching or pressure on a keyboard or touch screen device.

Mobile device 1100 may also comprise a dedicated camera device 1164 for capturing still or moving imagery. Camera device 1164 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose/application processor 1111 or DSP(s) 1112. Alternatively, a dedicated video processor 1168 may perform conditioning, encoding, compression or manipulation of signals representing captured images. Additionally, video processor 1168 may decode/decompress stored image data for presentation on a display device (not shown) on mobile device 1100.

Mobile device 1100 may also comprise sensors 1160 coupled to bus 1101 which may include, for example, inertial sensors and environment sensors. Inertial sensors of sensors 1160 may comprise, for example accelerometers (e.g., collectively responding to acceleration of mobile device 1100 in three dimensions), one or more gyroscopes or one or more magnetometers (e.g., to support one or more compass applications). Environment sensors of mobile device 1100 may comprise, for example, temperature sensors, barometric pressure sensors, ambient light sensors, camera imagers, microphones, just to name few examples. Sensors 1160 may generate analog or digital signals that may be stored in memory 1140 and processed by DPS(s) or general purpose application processor 1111 in support of one or more applications such as, for example, applications directed to positioning or navigation operations.

In a particular implementation, mobile device 1100 may comprise a dedicated modem processor 1166 capable of performing baseband processing of signals received and downconverted at wireless transceiver 1121 or SPS receiver 1155. Similarly, modem processor 1166 may perform baseband processing of signals to be upconverted for transmission by wireless transceiver 1121. In alternative implementations, instead of having a dedicated modem processor, baseband processing may be performed by a general purpose processor or DSP (e.g., general purpose/application processor 1111 or DSP(s) 1112). It should be understood, however, that these are merely examples of structures that may perform baseband processing, and that claimed subject matter is not limited in this respect.

As used herein, the term “access point” is meant to include any wireless communication station and/or device used to facilitate communication in a wireless communications system, such as, for example, a wireless local area network, although the scope of claimed subject matter is not limited in this respect. Also, as used herein, the terms “access point” and “wireless transmitter” may be used herein interchangeably. In another aspect, an access point may comprise a wireless local area network (WLAN) access point, for example. Such a WLAN may comprise a network compatible and/or compliant with one or more versions of IEEE standard 802.11 in an aspect, although the scope of claimed subject matter is not limited in this respect. A WLAN access point may provide communication between one or more mobile devices and a network such as the Internet, for example.

As used herein, the term “mobile device” refers to a device that may from time to time have a position location that changes. The changes in position location may comprise changes to direction, distance, orientation, etc., as a few examples. In particular examples, a mobile device may comprise a cellular telephone, wireless communication device, user equipment, laptop computer, other personal communication system (PCS) device, personal digital assistant (PDA), personal audio device (PAD), portable navigational device, and/or other portable communication devices. A mobile device may also comprise a processor and/or computing platform adapted to perform functions controlled by machine-readable instructions.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, or combinations thereof.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions or information. Such storage devices may comprise any one of several media types including, for example, magnetic, optical or semiconductor storage media. Such storage devices may also comprise any type of long term, short term, volatile or non-volatile memory devices. However, these are merely examples of a storage medium, and claimed subject matter is not limited in these respects.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, or any combination of the above networks, and so on. A CDMA network may implement one or more radio access technologies (RATs) such as cdma2000, Wideband-CDMA (W-CDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. 4G Long Term Evolution (LTE) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (CDMA) cellular communication protocol, for example, and the femtocell may provide the mobile device access to a larger cellular telecommunication network by way of another broadband network such as the Internet.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method comprising, at a mobile device:
receiving a broadcast message from at least one access point including timing parameters of at least three access points, at least some of said timing parameters being determined at said at least one access point based, at least in part, on a measured time of arrival of beacon signals acquired at said at least one access point;
acquiring beacon signals at said mobile device from said at least three access points; and
computing an estimated location of said mobile device based, at least in part, on application of said timing parameters to times of arrival of said beacon signals acquired at said mobile device from said at least three access points.

2. The method of claim 1, wherein said access points comprise IEEE std. 802.11x access points.

3. The method of claim 1, wherein computing said estimated location of said mobile device further comprises computing said estimated location based, at least in part, on times of departure of said beacon signals acquired at said mobile device.

4. The method of claim 1, wherein at least some of said timing parameters of said at least three access points are determined based, at least in part, on times of departure of said beacon signals acquired at said at least one access point.

5. The method of claim 1, wherein computing said estimated location of said mobile device comprises computing said estimated location based, at least in part, on a combination of a known map feature with said application of said timing parameters to said times of arrival to resolve at least one ambiguity.

6. The method of claim 1, wherein computing said estimated location of said mobile device comprises computing said estimated location based, at least in part, on a combination of a known map feature with said application of said timing parameters to said times of arrival to resolve at least one ambiguity.

7. A mobile device comprising:
receiver; and
one or more processors to:
obtain a broadcast message received at said receiver from at least one access point including timing parameters of at least three access points, at least some of said timing parameters being determined at said at least one access point based, at least in part, on a measured time of arrival of beacon signals acquired at said at least one access point;
obtain a time arrival of at least one beacon signal acquired at said receiver from each of at least three access points; and
compute an estimated location of said mobile device based, at least in part, on application of said timing parameters to times of arrival of said beacon signals acquired at said receiver from said at least three access points.

8. The mobile device of claim 7, wherein said access points comprise IEEE std. 802.11x access points.

9. The mobile device of claim 7, wherein said estimated location of said mobile device is computed based, at least in part, on times of departure of said beacon signals acquired at said mobile device.

10. The mobile device of claim 7, wherein at least some of said timing parameters of said at least three access points are determined based, at least in part, on times of departure of said beacon signals acquired at said at least one access point.

11. The mobile device of claim 7, wherein said estimated location of said mobile device is computed based, at least in part, on a combination of a known map feature with said application of said timing parameters to said times of arrival to resolve at least one ambiguity.

12. The mobile device of claim 7, wherein said estimated location of said mobile device is computed based, at least in part, on a combination of a known map feature with said application of said timing parameters to said times of arrival to resolve at least one ambiguity.

13. A method comprising, at a first access point:
receiving one or more beacon signals transmitted from one or more other access points;
computing timing parameters of said one or more other access points relative to a timing reference of said first access point; and
broadcasting the computed timing parameters to mobile devices to enable said mobile devices to perform passive positioning operations based, at least in part, on application of the computed timing parameters to subsequently acquired beacon signals transmitted from the first access point and at least one of the one or more other access points.

14. The method of claim 13, wherein said timing parameters of at least one of said one or more other access points are determined relative to a timing reference local to said first access point.

15. The method of claim 13, wherein said timing parameters of at least one of said one or more other access points are determined based, at least in part, on an distance between said first access point and said at least one of said one or more other access points.

16. The method of claim 13, wherein the timing parameters of at least one of said one or more other access points is determined based, at least in part, on transmission times of one or more beacon signals acquired at said first mobile device according to a timing reference local to said at least one of said one or more other access points.

17. The method of claim 13, wherein said broadcasting the computed timing parameters to mobile devices comprises transmitting one or more broadcast messages including a timing reference of said first access point, timing parameters determined for at least one of said one or more other access points, and a MAC address of said at least one of said one or more other access points.

18. A first access point comprising:
a transceiver for wirelessly transmitting messages through and receiving messages from a wireless transmission medium; and
one or more processors to:
obtain one or more beacon signals received at said transceiver and transmitted from one or more other access points;
compute timing parameters of said one or more other access points relative to a timing reference of said first access point; and
initiate broadcasting of the computed timing parameters through said transceiver to mobile devices to enable said mobile devices to perform passive positioning operations based, at least in part, on application of the computed timing parameters to subsequently acquired beacon signals transmitted from the first access point and at least one of the one or more other access points.

19. The first access point of claim 18, wherein said timing parameters of at least one of said one or more other access points are determined relative to a timing reference local to said first access point.

20. The first access point of claim 18, wherein said timing parameters of at least one of said one or more other access points are determined based, at least in part, on an distance between said first access point and said at least one of said one or more other access points.

21. The first access point of claim 18, wherein the timing parameters of at least one of said one or more other access points is determined based, at least in part, on transmission times of one or more beacon signals acquired at said first mobile device according to a timing reference local to said at least one of said one or more other access points.

22. The first access point of claim 18, wherein said computed timing parameters are broadcasted through said transceiver in one or more broadcast messages including a timing reference of said first access point, timing parameters determined for at least one of said one or more other access points, and a MAC address of said at least one of said one or more other access points.
